(19) United States
(12) Patent Application Publication
(10) Pub. No.: US 2003/0007897 A1
(43) Pub. Date: Jan. 9, 2003

(54) Pipette tips

(76) Inventor: Andrew Creasey, Bedford, MA (US)

Correspondence Address: Edward D. Grieff, Esq., Hale and Dorr LLP, 1455 Pennsylvania Avenue, NW, Washington, DC, 20004, US

(21) Appl. No.: 09/899,027

(22) Filed: Jul. 6, 2001

(51) Int. Cl. B01L 3/02

(52) U.S. Cl. 422/100; 73/864.01

(57) ABSTRACT

The invention provides pipette tips having high affinity for target biomolecules and methods of using the pipette tips for separating, filtering, and purifying samples, preparing samples, culturing cells, and running assays.

### FIELD OF THE INVENTION

The invention provides pipette tips and methods of using the pipette tips to separate, filter, and purify samples, to prepare samples, to culture cells, and to run assays.

### BACKGROUND OF THE INVENTION

WO 01/07162 describes a surface-modified pipette tip where the interior walls of the pipette tip are coated with chromatography resins which bind biomolecules from a sample solution. The liquid sample can easily flow through the pipette tip, and the sample biomolecules can be eluted from the pipette tip in a subsequent step. The pipette tip described in WO 01/07162 is shown in FIG. 1. The pipette tip contains a housing 1, a distal end 2, an opening in the distal end 4, and an open proximal end 3. The open proximal end 3 of the pipette tip may be compatible with any pipetting device known in the art. The housing 1 is coated on its interior surface with a surface matrix coating 5 that comprises a polymer and a chromatographic material.

An improvement to the pipette tip in WO 01/07162 would involve, for example, an increase in the capacity of the pipette tip for binding biomolecules from a sample solution. The invention is directed to this, as well as other, important ends.

### SUMMARY OF THE INVENTION

The invention provides pipette tips having a tubular housing, a proximal end having an opening, a distal end having an opening, first particles adjacent the opening on the distal end, and second particles adjacent the first particles. The first and second particles may be about the same size, the first particles may be relatively larger than the second particles, or the first particles may be relatively smaller than the second particles. The first particles may be immobilized in the housing. The tubular housing, the first particles and/or the second particles may be physically and/or chemically modified with at least one functional group. The pipette tips of the invention may be in a single format or in pipette tip arrays of 2, 8, 12, 96, 384, 1,536, or other multi-pipette tip arrays.

The pipette tips of the invention may be used for filtering, separating and/or purifying biomolecules; for preparing biomolecules; for culturing cells; and/or for running assays.

The invention also provides methods to prepare biomolecules; to culture cells; and/or to run assays using pipette tips having a tubular housing, a proximal end, a distal end having an opening, and a surface matrix coating on the inside of the tubular housing. In other embodiments, the invention provides methods to prepare biomolecules; to culture cells; and/or to run assays using the pipette tips described in WO 01/07162.

These and other aspects of the invention are described in more detail herein.

### BRIEF DESCRIPTION OF THE FIGURES

FIG. 1 is a diagram of the pipette tip described in WO 01/07162.

FIG. 2 is a diagram of pipette tips of the invention.

### DETAILED DESCRIPTION OF THE INVENTION

The invention provides pipette tips having high affinity for target biomolecules due to the large surface area of the particles in the housing. The pipette tips of the invention have second particles (e.g., silica resins) on top of first activated or non-activated particles.

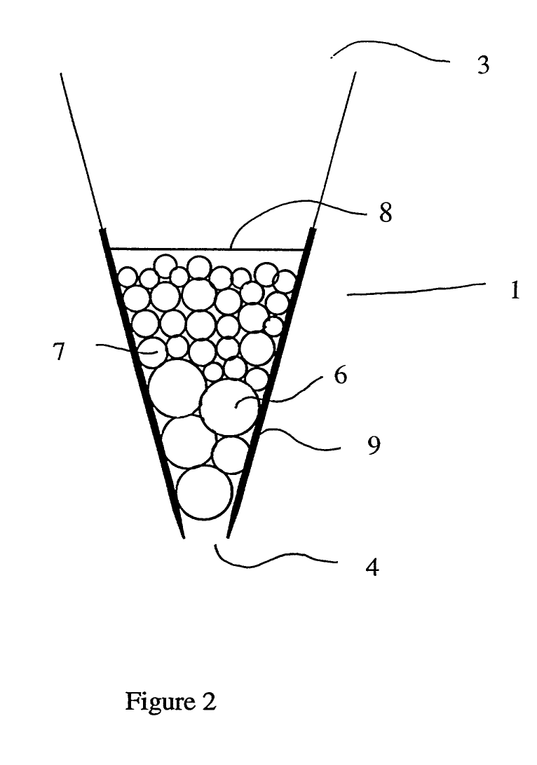

Referring to FIG. 2, the pipette tips have a housing 1. The housing 1 is preferably elongated and tubular, but other shapes may be used. An open proximal end 3 of the housing 1 is designed to receive and releaseably mate with a lower end of a pipette tip mounting shaft of a pipette device (not shown) while the distal end 2 is of a relatively reduced cross section and includes a relatively small opening 4 for passing fluids into and out of the housing 1 in response to operation of the pipette device. The housing 1 may be disposable, and may optionally have a cap (not shown) for the distal end 2 and/or the proximal end 3.

The housing may be made of any material known in the art. Exemplary materials include glass (e.g., PYREX® by Corning, Inc.) or one or more polymer materials. Exemplary polymer materials include polytetrafluoroethylenes (e.g., TEFLON® by DuPont), polysulfones, polyethersulfones, polypropylenes, polyetheretherketones, polymethyl methacrylates, polystyrenes, polystyrene/acrylonitrile copolymers, polyvinylidenefluorides, or mixtures thereof.

The inside of the housing may optionally be physically and/or chemically modified with any functional group known in the art. For example, the housing may be physically and/or chemically modified with chromatographic materials, enzymes, antibodies, cyclodextrins, lectins, metal ions, ligands, or mixtures thereof. The enzymes, antibodies, cyclodextrins, lectins, metal ions and ligands may be any known in the art. In other embodiments, the housing may be physically and/or chemically modified with, for example, poly-L-lysine, poly-D-lysine, DEAE-dextran, poly-L-arginine, poly-L-histine, poly-DL-ornithine, protamine, collagen type 1, collagen type IV, gelatin, fibronectin, laminin, chondronectin, or mixtures thereof.

The chromatographic materials may be any known in the art, including, for example, materials for ion-exchange chromatography, size-exclusion chromatography, affinity chromatography, gradient chromatography, hydrophobic/hydrophilic chromatography, chiral chromatography, or mixtures thereof. Exemplary chromatographic materials include polysaccharides (e.g., cellulose, agarose, crosslinked polysaccharide beads (commercially available as SEPHAROSE® and SEPHADEX®)), polymers (e.g., polystyrene, polytetrafluoroethylenes (e.g., TEFLON® from DuPont), styrenedivinyl-benzene based media, polymer beads, polymethyl methacrylates (PERSPEX®), polyacrylamide), silicas (e.g., silica, silica gel, silica gel-containing phosphors, glass, controlled pore glass), or metals (e.g., aluminum oxide, zirconium, titanium). The chromatographic materials may be chemically and/or physically modified, and may be porous or non-porous. For example, styrenedivinyl-benzene based media may be modified with, for example, sulphonic acids, quartemary amines and the like. Silicas may be modified with, for example, C₂, C₄, C₆, C₈ or C₁₈ or ion exchange functionalities. Chromatographic materials may be physically and/or chemically modified with, for example, enzymes, antibodies, cyclodextrins, lectins, metal ions, ligands, or mixtures thereof. In other embodiments, chromatographic materials may be physically and/or chemically modified with, for example, poly-L-lysine, poly-D-lysine, DEAE-dextran, poly-L-arginine, poly-L-histine, poly-DL-omithine, protamine, collagen type 1, collagen type IV, gelatin, fibronectin, laminin, chondronectin, or mixtures thereof. The chromatographic materials may have any regular (e.g., spherical) or irregular shape, or may be shards, fibers, powders or mixtures thereof.

The housing may be any size. For example, the housing may be from about 1 μl to about 1,000 μl. In other embodiments, the housing may be from about 1 μl to about 10 μl, or from about 10 μl to about 100 μl, or from about 100 ∥l to about 1,000 μl. Other housings of the invention may be from about 10 μl to about 300 μl, or from about 10 μl to about 100 μl.

The embodiments shown in FIG. 2 comprise second particles 7 on a bed of first particles 6 which are adjacent the distal end 2 of the housing 1. The first particles 6 form a 3-dimensional bed which provides support for the bed of second particles 7 without restricting liquid flow through the housing 1. In some embodiments, the first particles 6 may also serve as a suitable surface for binding biomolecules.

The first particles 6 may be immobilized at the distal end 2 of the housing 1 to prevent the second particles 7 from moving toward the distal end 2 of the housing 1.

In one embodiment, the first particles may be immobilized with one or more polymers known in the art. For example, the first particles may be immobilized with polytetrafluoroethylenes (e.g., TEFLON® by DuPont), polysulfones, polyethersulfones, polypropylenes, polyetheretherketones, polymethyl methacrylates, polystyrenes, polystyrene/acrylonitrile copolymers, polyvinylidenefluorides, or mixtures thereof. In preferred embodiments, the first particles may be immobilized with polytetrafluoroethylenes (e.g., TEFLON® by DuPont).

In another embodiment, the first particles may be immobilized with a polymer matrix. The polymer matrix may comprise at least one polymer and at least one chromatographic material. The polymer matrix may optionally comprise other materials such as, for example, other functional groups, gels, bacteria, living cells, solid powders or mixtures thereof. The polymer may be any known in the art. Exemplary polymers include polytetrafluoroethylenes (e.g., TEFLON® by DuPont), polysulfones, polyethersulfones, cellulose acetates, polystyrenes, polyvinylchlorides, polycarbonates, polystyrene/acrylonitrile copolymers, polyvinylidenefluorides, or mixtures thereof. The chromatographic materials may be any known in the art, including, for example, materials for ion-exchange chromatography, size-exclusion chromatography, affinity chromatography, gradient chromatography, hydrophobic/hydrophilic chromatography, chiral chromatography, or mixtures thereof. Exemplary chromatographic materials include polysaccharides (e.g., cellulose, agarose, crosslinked polysaccharide beads (commercially available as SEPHAROSE® and SEPHADEX®)), polymers (e.g., polystyrene, polytetrafluoroethylenes (e.g., TEFLON® from DuPont), styrenedivinyl-benzene based media, polymer beads, polymethyl methacrylates (e.g., PERSPEX®), polyacrylamide), silicas (e.g., silica, silica gel, silica gel-containing phosphors, glass, controlled pore glass), or metals (e.g., aluminum oxide, zirconium, titanium). The chromatographic materials may be chemically and/or physically modified, and may be porous or non-porous. For example, styrenedivinyl-benzene based media may be modified with, for example, sulphonic acids, quarternary amines and the like. Silicas may be modified with, for example, C₂, C₄, C₆, C₈ or C₁₈, or ion exchange functionalities. The chromatographic materials may be physically and/or chemically modified with, for example, enzymes, antibodies, cyclodextrins, lectins, metal ions, ligands, or mixtures thereof. In other embodiments, the chromatographic materials may be physically and/or chemically modified with, for example, poly-L-lysine, poly-D-lysine, DEAE-dextran, poly-L-arginine, poly-L-histine, poly-DL-ornithine, protamine, collagen type 1, collagen type IV, gelatin, fibronectin, laminin, chondronectin, or mixtures thereof. The chromatographic materials in the polymer matrix may have any regular (e.g., spherical) or irregular shape, or may be shards, fibers, powders or mixtures thereof.

The first particles 6 are added to the housing 1 and bedded down at the distal end 2 of the housing 1. To immobilize the first particles, one or more polymers (e.g., TEFLON®) or a polymer matrix is added to the open proximal end 3 of the housing 1 to coat the first particles 6 and, optionally, the interior surface 9 of the housing 1. The polymer or polymer matrix is dried by air drying, heating or vacuum drying. The dried polymer or dried polymer matrix immobilizes the first particles 6 in the distal end 2 of the housing 1. The term “coat” means that the first particles 6 and the interior surface 9 of the housing 1 may be partially or completely covered with the polymer or polymer matrix. The objective is to immobilize the first particles, which may be done without completely covering the first particles and/or the interior surface of the housing with the polymer or polymer matrix. The interior surface 9 of the housing 1 may be coated with the polymer or polymer matrix at any location between the distal end 2 and proximal end 3 of the pipette tip.

The first particles may be any size. The first particles are preferably a size that is larger than the opening in the distal end of the pipette tip. For example, the first particles may have a size from about 300 μm to about 1000 μm. In other embodiments, the first particles may have a size from about 400 μm to about 1000 μm. The first particles may have any regular (e.g., spherical) and/or irregular shape.

The first particles may be any material known in the art, such as glass (e.g., PYREX® by Coming, Inc.), plastic, chromatographic materials, or mixtures thereof. The first particles may be modified with any functional group known in the art. The first particles may be physically and/or chemically modified with, for example, enzymes, antibodies, cyclodextrins, lectins, metal ions, ligands, or mixtures thereof. In other embodiments, the first particles may be physically and/or chemically modified with, for example, poly-L-lysine, poly-D-lysine, DEAE-dextran, poly-L-arginine, poly-L-histine, poly-DL-omithine, protamine, collagen type 1, collagen type IV, gelatin, fibronectin, laminin, chondronectin, or mixtures thereof.

The first particles may be any chromatographic material known in the art, including, for example, materials for ion-exchange chromatography, size-exclusion chromatography, affinity chromatography, hydrophobic/hydrophilic chromatography, chiral chromatography, and mixtures thereof. Exemplary chromatographic materials include polysaccharides (e.g., cellulose, agarose, crosslinked polysaccharide beads (commercially available as SEPHAROSE® and SEPHADEX®)), polymers (e.g., polystyrene, polytetrafluoroethylenes (e.g., TEFLON® from DuPont), styrenedivinyl-benzene based media, polymer beads, polymethyl methacrylates (e.g., PERSPEX®), polyacrylamide), silicas (e.g., silica, silica gel, silica gel-containing phosphors, glass, controlled pore glass), or metals (e.g., aluminum oxide, zirconium, titanium). The large chromatographic particles may be chemically and/or physically modified, and may be porous or non-porous. For example, styrenedivinyl-benzene based media may be modified with, for example, sulphonic acids, quartemary amines and the like. Silicas may be modified with, for example, C₂, C₄, C₆, C₈ or C₁₈, or ion exchange functionalities. The chromatographic materials may be physically and/or chemically modified with, for example, enzymes, antibodies, cyclodextrins, lectins, metal ions, ligands, or mixtures thereof. In other embodiments, the chromatographic materials may be physically and/or chemically modified with, for example, poly-L-lysine, poly-D-lysine, DEAE-dextran, poly-L-arginine, poly-L-histine, poly-DL-omithine, protamine, collagen type 1, collagen type IV, gelatin, fibronectin, laminin, chondronectin, or mixtures thereof.

The second particles 7 are added to the proximal end 3 of the housing 1 after the first particles 6 are immobilized at the distal end 2 of the housing 1. The second particles 7 may be selectively chosen to efficiently bind biomolecules from a given sample with high affinity. The second particles may have any regular (e.g., spherical) or irregular shape. The second particles 7 may be located above, adjacent, and/or below the proximal end of the polymer or polymer matrix that coats the interior surface 9 of the housing 1.

After the second particles 7 have been added to the housing 1, a frit 8 may optionally be inserted into the proximal end 3 of the housing 1 adjacent the second particles 7 to prevent the second particles 7 from falling out of the housing 1, particularly during shipping or storage. The frit 8 may be located above, adjacent, or below the proximal end of the polymer or polymer matrix that coats the interior surface 9 of the housing 1. The frit 8 may be made of porous, non-reactive materials (e.g., ceramics). The frit 8 may be added to the housing 1 to create a physical barrier between the second particles 7 and the open proximal end 3 of the housing 1. The frit 8 may optionally be removed from the housing 1 prior to using the pipette tips in the methods described herein.

In one embodiment, the second particles are relatively smaller than the first particles.

“Relatively smaller” means that the second particles are at least about 1 μm smaller than the first particles, preferably at least about 5 μm, more preferably at least about 10 μm, more preferably at least about 15 μm. For example, the first particles may be from about 300 μm to about 1000 μm; and the second particles may be from about 1 μm to less than 1000 μm, preferably from about 5 μm to less than 1000 μm, more preferably from about 300 μm to less than 1000 μm, wherein the second particles are relatively smaller than the first particles. In other embodiments, the second particles may be from about 1 μm to about 400 μm, preferably from about 5 μm to about 400 μm, wherein the second particles are relatively smaller than the first particles. In still other embodiments, the second particles may be from about 1 μm to about 300 μm, preferably from about 5 μm to about 300 μm, wherein the second particles are relatively smaller than the first particles.

In other embodiments, the second particles may be about the same size as the first particles. “About the same size” means that the size of the first particles are ±15 μm the size of the second particles, preferably ±10 μm, more preferably ±5 μm, still more preferably ±1 μm. For example, the first particles and the second particles may be from about 300 μm to about 1000 μm, wherein the first particles and the second particles are about the same size. In other embodiments, the first particles and the second particles may have a size from about 1 μm to about 1000 μm, or from about 5 μm to about 1000 μm, or from about 400 μm to about 1000 μm, wherein the first particles and the second particles are about the same size In other embodiments, the second particles may be relatively larger than the first particles. “Relatively larger” means that the second particles are at least about 1 μm larger than the first particles, preferably at least about 5 μm, more preferably at least about 10 μm, more preferably at least about 15 μm. For example, the first particles may be from about 300 μm to about 1000 μm; and the second particles may be from about 300 μm to about 1000 μm, wherein the second particles are relatively larger than the first particles. In other embodiments, the first particles and the second particles may be from about 1 μm to about 1000 μm, or from about 5 μm to about 1000 μm, or from about 400 μm to about 1000 μm, wherein the second particles are relatively larger than the first particles.

The second particles may be any chromatographic material known in the art, including, for example, materials for ion-exchange chromatography, size-exclusion chromatography, affinity chromatography, hydrophobic or hydrophilic chromatography, chiral chromatography, or mixtures thereof. Exemplary chromatographic materials include polysaccharides (e.g., cellulose, agarose, crosslinked polysaccharide beads (commercially available as SEPHAROSE® and SEPHADEX®)), polymers (e.g., polystyrene, polytetrafluoroethylenes (e.g., TEFLON® from DuPont), styrenedivinyl-benzene based media, polymer beads, polymethyl methacrylates (e.g., PERSPEX®), polyacrylamide), silicas (e.g., silica, silica gel, silica gel-containing phosphors, glass, controlled pore glass), or metals (e.g., aluminum oxide, zirconium, titanium). The second particles may be chemically and/or physically modified, and may be porous or non-porous. For example, styrenedivinyl-benzene based media may be modified with, for example, sulphonic acids, quartemary amines and the like. Silicas may be modified with, for example, C₂, C₄, C₆, C₈ or C₁₈, or ion exchange functionalities. The second particles may be physically and/or chemically modified with, for example, functional groups, enzymes, antibodies, cyclodextrins, lectins, metal ions, ligands, or mixtures thereof. In other embodiments, the second particles may be physically and/or chemically modified with, for example, poly-L-lysine, poly-D-lysine, DEAE-dextran, poly-L-arginine, poly-L-histine, poly-DL-omithine, protamine, collagen type 1, collagen type IV, gelatin, fibronectin, laminin, chondronectin, or mixtures thereof. In one embodiment, the second particles may be silica particles for binding DNA or bonded silica particles for binding of other biomolecules.

The pipette tips of the invention may be in a single format or in a multiple pipette tip array, such as 2, 8, 12, 96, 384, 1,536 or other number arrays, to be used with standard well plates. When used in an array, the pipette tips in the array may be the same or different. For example, the pipette tips may have the same or different sizes and may use the same or different first particles and/or second particles.

The pipette tips may be used in bi-directional applications (e.g., from the proximal end of the housing to the distal end of the housing and/or from the distal end of the housing to the proximal end of the housing). The pipette tips of the invention may be used with any robotic system or automated apparatus, such as computer-controlled bench-top systems designed for performing pipetting operations.

The pipettes of the invention may be use in any repetitive chemical process requiring synthesis or degradation. For example, the pipette tips may be used in the synthesis of a variety of oligomers, such as polypeptides, polysaccharides, and oligonucleotides.

The pipette tips of the invention may be used for filtering, separating and/or purifying biomolecules (e.g., oligonucleotides, peptides, DNA, RNA, proteins) using chromatography materials. The chromatography materials may be ion-exchange chromatography, size-exclusion chromatography, affinity chromatography, hydrophobic/hydrophilic chromatography, gradient chromatography, chiral chromatography, or mixtures thereof. Chromatographic methods for filtering, separating and/or purifying bio-materials are known in the art. In the invention, samples and biomolecules may be filtered, separated and/or purified by adding the samples and/or biomolecules to the proximal end of the pipette tip. Alternatively, samples and biomolecules may be filtered, separated and/or purified by pipetting the samples and/or biomolecules up from the distal end into the pipette tip from, for example, a well plate, beaker, or other source. For example, a sample may be added to the pipette tip. Solvents may then be added to the pipette tip to remove the impurities from the sample and to maintain the compound of interest in the pipette tip. After the impurities have been removed, the purified sample may be released from the pipette tip with an appropriate solvent or buffer.

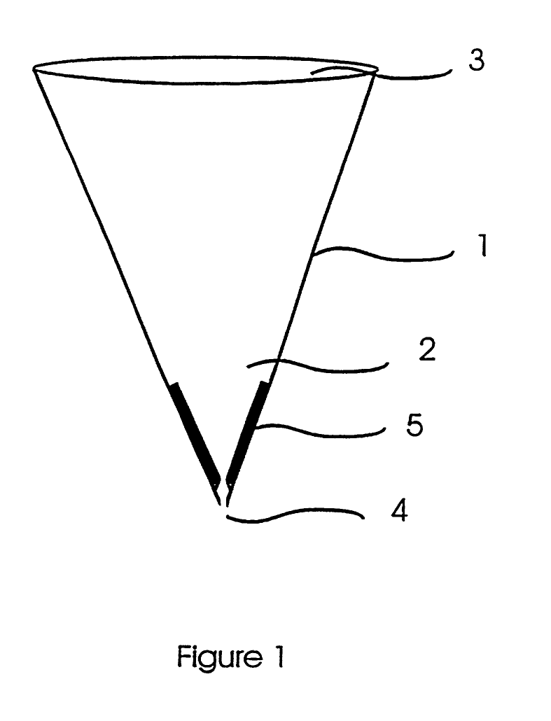

The pipette tips of the invention may also be used for preparing biomolecules (e.g., oligonucleotides, peptides, DNA, RNA, proteins). The methods of the invention may be performed with the pipette tips shown in FIGS. 1 and 2. For example, oligonucleotides may be prepared using the pipette tips of the invention. An initial protected nucleoside may be bound via the terminal 3′ hydroxyl group to a solid support (i.e., chromatographic material) in the pipette tip. The initial protected nucleoside may be bound to the polymer matrix, first particles and/or second particles when the pipette tip is made. Alternatively, the initial protected nucleoside may be added to a pipette which has been made to contain appropriate chromatographic materials that will bind and retain the nucleoside.

Reagents and solvents may be added to the pipette tip to consecutively remove and add sugar protecting groups to isolate the reactivity of a specific chemical moiety on the monomer and affect its stepwise addition to the growing oligonucleotide chain. Unreacted reagents may be eluted from the pipette tip. The steps for preparing oligonucleotides, e.g., deblocking, activating/coupling, oxidating, capping, are well known in the art and may be followed to produce oligonucleotides in the pipette tips of the invention. Once the oligonucleotides are formed, they may be removed from the pipette tip using known reagents. RNA synthesis may be performed in the same manner, except that an additional protecting group would be used at the 2′ hydroxyl moiety of the ribose.

The pipette tips of the invention may be used for culturing cells. The methods of the invention may be performed with the pipette tips shown in FIGS. 1 and 2. Any cell line (including hybridomas) known in the art can be cultured in the pipette tips of the invention, including, for example, cell lines available from the ATCC and the ECACC. The cell cultures can be grown from normal, embryonic and malignant tissues.

For adherent cells, the inside of the pipette tips may have a suitable surface on which the cells may adhere or the pipette tips may contain a polymer matrix, first particles and/or second particles that would provide a suitable surface on which the cells may adhere. For growing adherent cells, the pipette tips, the polymer matrix, first particles and/or second particles may preferably comprise polystyrenes, polytetrafluoroethylenes, polyvinylchlorides, polycarbonates, and/or titanium. The pipette tips, polymer matrix, first particles and/or second particles may also further comprise coating agents, such as, for example, poly-L-lysine, poly-D-lysine, DEAE-dextran, poly-L-arginine, poly-L-histine, poly-DL-omithine, protamine, collagen type 1, collagen type IV, gelatin, fibronectin, laminin, chondronectin, or mixtures thereof.

Biological stains (e.g., giemsa, crystal violet, hematoxylin, eosin, methyl green/pyronin) may be added to the cell cultures to provide details of cell morphology, to check the viability of the cells, to counterstain, and to check for contamination. Antibody labels (e.g., fluorochrome, radioisotopes, enzymes, colloidal gold, ferritin, biotin/avidin) can also be incubated with the cells to permit identification of the cells.

For culturing cells and hybridomas, any media known in the art can be used. The components of the media may include a mixture of salts, carbohydrates, amino acids, co-factors, trace elements, nucleosides, ribonucleosides, vitamins, hormones, and/or growth factors. Other components in the media may be, for example, antibiotics, pyruvate, glutathione, phenol red, glucose, bactopeptone, insulin, linoleate, galactose, acetate, Hepes, CO₂ gas, and the like. Exemplary media include serum-based media and serum-free media.

The cells cultured by the methods of the invention may be cryopreserved without removing the cells from the pipette tip. Accordingly, cryopreservatives may be added to the cell cultures. Methods for cryopreservation are known in the art.

The pipette tips of the invention may be used for running assays. The methods of the invention may be performed with the pipette tips shown in FIGS. 1 and 2. Assays known in the art include, for example, enzyme-linked immunosorbent assays (ELISA), sandwich assays, competitive assays, latex agglutination assays, radio-immunoassays (RIA), fluorescent immunoassays (FIA), and the like.

For example, to use the pipette tips of the invention to conduct a binding assay (e.g., receptor-ligand assay), a protein sample (e.g., receptor) may be added to the pipette tip that comprises a chromatographic material capable of binding the protein (Alternatively, the pipette tip may be constructed to contain the proteins of interest). A second sample comprising small molecules (e.g., ligand) may then be added to the pipette tip, but which can only bind to the proteins in the pipette tip. After the second sample passes through the pipette tip, the bound protein-small molecule materials may then be eluted with the appropriate solvent or buffer. Quantitative and/or qualitative assays may then be performed to further study the samples. By choosing appropriate chromatographic materials, the pipette tips of the invention may also be used to study DNA-protein interactions, protein-protein interactions, and many other interactions between biomolecules and other molecules.

The pipette tips of the invention may be present in the form of a kit. The kit may comprise the pipette tips of the invention and any materials known in the art, such as any materials used in performing the methods described herein. For example, the kit may comprise one or more pipette tips (e.g., pipette tips of the invention or other pipette tips), caps for the pipette tips, collection tubes, well plates, clamps, membranes, growth blocks, filters, plate rotators, syringes, chromatographic materials, reagents, buffers, cells, and/or a user manual. The term “kit” includes, for example, each of the components combined in a single package, the components individually packaged and sold together, or the components presented together in a catalog (e.g., on the same page or double-page spread in the catalog).

### EXAMPLES

The following examples are for purposes of illustration only and are not intended to limit the scope of the appended claims.

### Example 1

Controlled pore glass beads approximately 400 μm in diameter were placed into a 100 μl pipette tip. 50 μl of a slurry containing silica and TEFLON® (a fluoropolymer resin by DuPont) was dispensed into the pipette tip and drawn through the controlled pore glass bead bed using a vacuum manifold. About 50 mg of 80 mesh (i.e., 177 μm) silica particles were then dispensed into the tip and allowed to settle. The resulting pipette tip is generally represented by FIG. 2.

### Example 2

Plasmid DNA from 1 ml of a cleared alkaline lysate of an overnight E. coli culture was bound to the pipette tip prepared in Example 1, washed and eluted from the pipette tip with water. The procedure yielded about 1.6 mg of purified plasmid DNA.

Various modifications of the invention, in addition to those described herein, will be apparent to one skilled in the art from the foregoing description. Such modifications are intended to fall within the scope of the appended claims.

What is claimed is:

1. A pipette tip comprising a housing, a proximal end having an opening, a distal end having an opening, first particles adjacent the opening on the distal end, and second particles adjacent the first particles, wherein the first particles are immobilized in the housing.

2. The pipette tip of claim 1, wherein the housing is physically or chemically modified with at least one functional group.

3. The pipette tip of claim 1, wherein the first particles have a size from about 300 μm to about 1000 μm.

4. The pipette tip of claim 1, wherein the first particles are glass, plastic, a chromatographic material, or a mixture thereof.

5. The pipette tip of claim 1, wherein the first particles are chemically or physically modified with at least one functional group.

6. The pipette tip of claim 1, wherein the first particles are immobilized in the housing with at least one polymer.

7. The pipette tip of claim 1, wherein the first particles are immobilized in the housing with a polymer matrix.

8. The pipette tip of claim 1, wherein the second particles have a size from about 5 μm to about 400 μm.

9. The pipette tip of claim 1, wherein the second particles are ion-exchange chromatography materials, size-exclusion chromatography materials, affinity chromatography materials, hydrophobic chromatography materials, hydrophilic chromatography materials, chiral chromatography materials, or a mixture thereof.

10. The pipette tip of claim 1, wherein the second particles are chemically or physically modified with at least one functional group.

11. The pipette tip of claim 10, wherein the functional group is a chromatographic material, an enzyme, an antibody, a cyclodextrin, a lectin, a metal ion, a ligand, or a mixture thereof.

12. The pipette tip of claim 1, wherein the housing has a volume from about 1 μl to about 1,000 μl.

13. A kit comprising the pipette tip of claim 1.

14. A pipette tip array comprising at least 2 pipette tips of claim 1.

15. A pipette tip array comprising at least 8 pipette tips of claim 1.

16. A pipette tip array comprising at least 12 pipette tips of claim 1.

17. A pipette tip array comprising at least 96 pipette tips of claim 1.

18. A pipette tip array comprising at least 384 pipette tips of claim 1.

19. A pipette tip array comprising at least 1,536 pipette tips of claim 1.

20. A pipette tip comprising a housing, a proximal end having an opening, a distal end having an opening, first particles adjacent the opening on the distal end, and second particles adjacent the first particles, wherein the first particles are immobilized in the housing, wherein the first particles have a size from about 300 μm to about 1000 μm, wherein the second particles have a size from about 1 μm to about 1000 μm, and wherein the second particles are relatively smaller than the first particles.

21. The pipette tip of claim 20, wherein the second particles have a size from about 5 μm to about 400 μm.

22. The pipette tip of claim 21, wherein the second particles have a size from about 5 μm to about 300 μm.

23. A pipette tip comprising a housing, a proximal end having an opening, a distal end having an opening, first particles adjacent the opening on the distal end, and second particles adjacent the first particles, wherein the first particles are immobilized in the housing, wherein the first particles have a size from about 300 μm to about 1000 μm, wherein the second particles have a size from about 300 μm to about 1000 μm, and wherein the second particles are about the same size as the first particles.

24. A pipette tip comprising a housing, a proximal end having an opening, a distal end having an opening, first particles adjacent the opening on the distal end, and second particles adjacent the first particles, wherein the first particles are immobilized in the housing, wherein the first particles have a size from about 300 μm to about 1000 μm, wherein the second particles have a size from about 300 μm to about 1000 μm, and wherein the second particles are relatively larger than the first particles.
